(19) United States
(12) Patent Application Publication
(10) Pub. No.: US 2007/0079445 A1
(43) Pub. Date: Apr. 12, 2007

(54) Combination tool

(76) Inventor: Roy Siebeck, Jackson, WY (US)

Correspondence Address: SANTANGELO LAW OFFICES, P.C., 125 SOUTH HOWES, THIRD FLOOR, FORT COLLINS, CO, 80521, US

(21) Appl. No.: 11/635,966

(22) Filed: Dec. 8, 2006

Related U.S. Application Data
(63) Continuation-in-part of application No. PCT/US05/20309, filed on Jun. 8, 2005.
(60) Provisional application No. 60/578,133, filed on Jun. 8, 2004.

(51) Int. Cl. B25F 1/00; B25D 1/04; B25B 7/22

(52) U.S. Cl. 7/129; 7/144; 7/164

(57) ABSTRACT

At least one embodiment of the inventive technology may be a combination tool apparatus that comprises a first tool part having a first plier jaw and a second tool part having a second plier jaw rotatable relative to an axis of rotation; compressive grip surfaces; a hammer head; a wire cutter element; a wire stripper element; and a handle. In certain of the many embodiments, the hammer head may be established within certain dimensional constraints relative to other part(s) of the tool, and/or the apparatus may not comprise a nail pulling claw.

This application is continuation in part of international application PCT/US2005/020309 filed 08 Jun. 2005, now abandoned, which claims priority to U.S. Provisional Application No. 60/578,133, filed 8 Jun. 2004, each hereby incorporated herein by reference.

### TECHNICAL FIELD

Generally, this invention relates to combination tool apparatus and related methods for accomplishing specific work tasks in an increased efficiency manner. Specifically, the invention focuses upon apparatus and related methods relative to a combination tool (and perhaps methods of use thereof) that is adapted to have certain alternate functionalities—wire cutting, wire stripping, hammering, and “pliering” and/or that has a hammer head that may be established within certain dimensional constraints relative to other part(s) of the tool.

### BACKGROUND

The desire to improve work efficiency has been known for some years. The broad concept of a combination tool has been known for some time, but available combination tools have included features or capabilities that have compromised overall tool suitability and/or performance for a certain job (e.g., the jobs performed by linesman, electricians, and tinners), or that have not included features or capabilities that would enhance overall combination tool suitability and operation for an intended job (e.g., wire installation in a crawlspace). While resolution of these problems has long been desired, a successful design that affords necessary capabilities in a compact, robust, weight appropriate and low profile design has not been available. At least one embodiment of the invention seeks to provide such a design.

A key application of the present invention is within electrician, linesman and tinner trades. They, at times, may involve jobs whose essential tool requirements are similar, enabling the use of a similar combination tool.

### DISCLOSURE OF INVENTION

At least one embodiment of the inventive technology may be a combination tool apparatus that comprises a first tool part having a first plier jaw and a second tool part having a second plier jaw rotatable relative to an axis of rotation; compressive grip surfaces; a hammer head; a wire cutter element; a wire stripper element; and a handle. In certain of the many embodiments, the hammer head may be established within certain dimensional constraints relative to other part(s) of the tool, and/or the apparatus may not comprise a nail pulling claw. Particular embodiments may incorporate a non-contact voltage sensor.

### BRIEF DESCRIPTION OF THE DRAWINGS

It should be understood that the figures are not to be limiting in any fashion, as they provide specifics as to only at least one embodiment of the invention.

FIG. 1 shows a view of at least one embodiment of the combination tool invention.

FIG. 2 shows a slightly perspective view of at least one embodiment of the combination tool invention.

FIG. 3 shows a view of at least one embodiment of the combination tool invention.

FIG. 4 shows a view of at least one embodiment of the combination tool invention.

FIG. 5 shows a view of at least one embodiment of the combination tool invention, in particular showing an apparatus incorporating a non-contact voltage sensor.

### MODES FOR CARRYING OUT THE INVENTION

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should further be understood to support and encompass descriptions and claims of all the various embodiments, systems, techniques, methods, devices, and applications with any number of the disclosed elements, with each element alone, and also with any and all various permutations and combinations of all elements in this or any subsequent application.

At least one embodiment of the inventive technology may achieve a proper balance of weight (and size) and multi-functionality—which may be important to certain types of workers (tinners, electricians and linesman, as but a few examples), as they often work in tight spaces. It is their often cramped working area that makes a low profile tool beneficial, as such a tool often reduces the incidence of annoying hitting of the tool into obstructions. Further, the fact that the tool must often be carried to the work area and the fact that many jobs require a repeating of a similar motion (e.g., hammering) makes a tool that is not improperly heavy desirable.

The invention may further reflect the selection of only a few (e.g., four) tool functionalities or capabilities that are most needed by certain laborers (e.g., tinners, electricians and linesman), with potential resultant benefits including the readily accessible provision of the capabilities (e.g., wire cutting, wire stripping, hammering and “pliering”) that are most often needed, without providing so many tools that the combination tool is heavy and cumbersome and has an unacceptably high profile. As used herein, the term “pliering” refers to those tasks that can be accomplished by a pair of pliers; they include but are not limited to cable pulling, grasping, and wire splicing. Embodiments of the combination tool, where the four tools may be combined as one tool (forming a “four-in-one” tool), may provide the appropriate balance between multi-functionality, weight, ease of use and manufacture, and profile.

As used herein, the term tool refers to the structure(s) that, upon manipulation by a user, provide the indicated capability(ies). For example, a wire stripping tool has those structures that can be used to strip wire. A tool may have only one functionality (e.g., a hammer head tool, which can only be used to accomplish the well known tasks of a hammer head) or it may have more than one functionality (a combination tool). It should be understood that, although a pair of pliers can indeed be used to do many things (again, including cable pulling, grasping and wire splicing), even a pair of pliers is deemed to have only one functionality—“pliering”—and thus is not considered a combination tool. This inventive technology focuses on a combination tool, and various embodiments thereof.

It should be understood that, of course, the selection of which functional structures (pliers, wrench, hammer, nail removing claw, pry bar, saw and awl, as but a few examples) are to be combined to provide the desired capabilities of the combination tool without resulting in a combination tool that is overly complex (relative to use or manufacture), heavy, or highly profiled may per se afford operational benefits. The tools selected are of course some of the more needed tools in certain applications (e.g., electrical wiring), but it should also be noted that none of the tools selected have unique needs (e.g., a power cord or a combustible fuel source) that would render the whole tool cumbersome and/or compromise its mobility, e.g.

A combination tool having those functionalities as present in at least one embodiment of the invention (e.g., wire stripper, wire cutter, hammer head and pliers) has surprising benefits relative to weight, economy of motion, job efficiency and low profile (as but a few). Indeed, the conventional thinking appears to have been that the more functionalities provided by a combination tool, the better the overall function of that tool. But the inventor of the technology disclosed herein has determined that, indeed, when only a certain number of capabilities are selected and the only capabilities enabled by the tool are among this limited set, the resulting combination tool offers enhanced overall operability relative to previously available combination tools. Further, as to at least some embodiments, the inventor has determined that certain relative placements or orientations of structures that provide certain of the combination tool's capabilities may contribute to the enhancement of operation of the combination tool.

At least one embodiment of the inventive technology is a simple and effective product designed as a tool that combines the capabilities of a wire cutter, wire stripper, pliers and a hammer in one contiguous apparatus. The product may be viewed as eliminating the effort and time consuming need to re-position a singularly functional tool (e.g., a pair of pliers) back into a storage position (e.g., on a tool belt) after it is no longer needed, and thereafter retrieving (perhaps from that same tool belt) a different tool that provides the needed capability. Instead, with the instant technology, perhaps all that need be done is a simple repositioning of the combination tool in the user's hand (if even that is necessary) so that the newly needed capability offered by the combination tool can then be used.

As but one example, perhaps with traditional technologies, once a certain hammering operation was completed (e.g., hammering staples to secure wiring), it may be desired to strip or cut part of that wire. Or, instead, after a pair of pliers (a singularly functional tool) was used to pull wire tight, it may be desired to fully hammer in a wire staple(s) that has only been partially hammered in. For each of these sequential operations, traditional technologies may have required two tools and thus required the above-mentioned effort and time consuming “switching” of the tools (and typically also the re-storage of the tool that is no longer needed). In a cramped environment (where much wiring occurs) such as a crawl space, this switching and restorage can be awkward and difficult, especially where the laborer, contractor or tradesman (each a potential type of user of the tool) is positioned on his or her back. Further, a multitude of individual tools takes up more storage space (e.g., on an tool belt) than does a combination tool having desired functionalities. Having a combination tool that has those functionalities that are needed but does not have those functionalities that typically are not needed or that are simply too cumbersome may result in a tool that is not too bulky or heavy. Such a tool may afford distinct advantages in that not only may the electricians, tinners and other laborers be able to complete a job more quickly and with less effort, but also construction and repair costs may be decreased.

What may also be a relevant feature(s) of at least one embodiment of the inventive technology is the proper positioning of the different parts of the positions and orientations relative to each other and/or the user's hand. Further, the actual shape or configuration of those part(s) of the tool that afford a particular functionality (e.g., the shape, size, orientation, and/or establishment (e.g., location) of the hammer head) may itself afford an unexpected benefit(s). Each of these aspects may facilitate “switching” of the combination tool's functionality, or the operation of a specific functionality, to an unexpected and surprising degree.

Selection of appropriate functionalities (e.g., wire cutting, wire stripping, hammering and “pliering” may result in a tool that has the “in-demand” functionalities without having so many functionalities (e.g., without having an adjustable wrench) that the tool becomes overly complex, cumbersome, or heavy, or simply requires too much manipulative precision (e.g., finger adjusting an adjustment screw) to operate one desired function. As one might expect, a tool having a crescent wrench, vice grips, work light, a claw hammer, hammer head, scissors, a pry bar, a Phillips and standard head screwdriver, and a channel lock wrench might be so complex that it would likely often be difficult to isolate one specific capability so that it could be used. Indeed, such a tool might even require two hands to isolate and use a specific capability—perhaps the scissors would need to be extracted or the screwdriver might need partial assembly. This is time consuming, and may require much effort in a cramped space. Also it would likely be a cumbersome tool having a high profile that does not fit in a tool belt and that might annoyingly hit against walls, etc. more than would a low profile design. Further, the more capabilities a tool has, the more mechanical problems it can have and the more maintenance it may require, and of course, the more difficult to manufacture and expensive it may be. Further, such a tool may have so many parts and/or be of such intricate design that it is simply not sturdy or durable enough for certain applications.

Indeed, a less complex tool having only a few key functionalities (e.g., four functionalities, including wire stripping, wire cutting, hammering and “pliering”) whose structures are: appropriately configured; and/or positioned relative to each other and/or the user's hand; and/or appropriately shaped might have a yet unseen, appropriate balance between affording needed capabilities and having certain beneficial characteristics, such as relatively low profile, relatively low weight, relative simplicity (e.g., enabling one handed tool “switching” maneuvers for any possible tool switching scenario), affordability and ability to withstand harsh working conditions.

In at least one embodiment of the invention, the combination tool apparatus 1 may comprise (or perhaps consist essentially of) a first tool part 2 and a second tool part 3 rotatably movable relative to the first tool part about an axis of rotation 24, where the first tool part may comprise a first plier jaw 4 and the second tool part may comprise a second plier jaw 5 that is established opposite the first jaw; compressive grip surfaces 6 established as part of said first plier jaw and said second plier jaw; a hammer head 7 fixedly established (e.g., by welding or molding) as part of the first tool part; a wire cutter element 8 adapted to cut wire during rotation of said first jaw relative to said second jaw (e.g., rotation of the first jaw towards and perhaps against the second jaw); and a wire stripper element 9 adapted to cut wire insulation, e.g., when the first jaw is rotated towards and possibly also against the second jaw, as part of a wire stripping process. A portion of each the first tool part and the second tool part together may form a handle 10 for grasping the combination tool apparatus. The jaws may include those structure(s) on the side of the axis of rotation opposite the handle whose inner surface separate and converge during opening and closing of the tool. The rotational movement of the second tool part 3 relative to the first tool part about an axis of rotation may result from rotational egagement of the two parts, which may be accomplished, in part, by a pin 36 that may form part of either tool part and pass through a hole disposed in the other tool part, enabling sliding movement between contacting parts. Such manufacture—as well as manufacture of all aspects of the apparatus—is well within the capabilities of those having ordinary skill in the art of tool manufacturing.

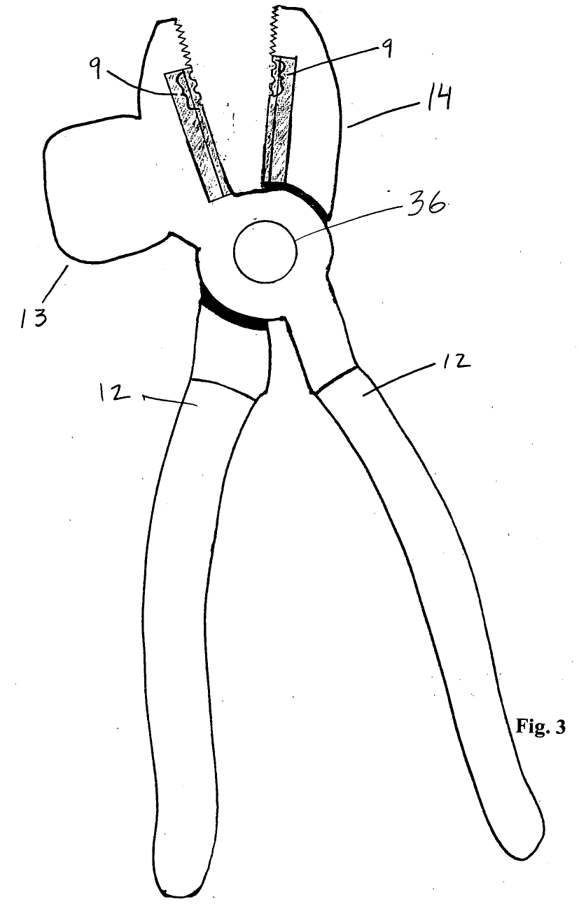

Either or both of said wire cutter element and said wire stripper element may be established as part of said first jaw and said second jaw; either or both may be established as part of opposing surfaces 11 of said first jaw and said second jaw. The wire cutter element may be side cutting (see FIG. 3 for a view showing the recessed side of the wire cutter element, as may also be found in prior art side-cutting linesman pliers), or center cutting (as but two examples), and may be adapted to cut wire during rotation of the first jaw relative to the second jaw, and the wire stripper element may be adapted to cut wire insulation during rotation of the first jaw relative to the second jaw. Of course, such may occur only after the wire to be cut or stripped is properly positioned, and only a portion of the entire range of rotational motion of the jaws is need to accomplish either the cut of the wire (a term typically meaning the current carrying portion and the insulation surrounding it) or merely the wire insulation (so that part of the insulation can be stripped off).

The hammer head may be fixedly established as part of the first tool part of the combination tool as by welding, e.g., or by molding techniques (as but one additional example). Indeed, any method (bolting, adhesive, welding, molding, extrusion, etc.) may be used to fixedly establish the hammer head as part of the first tool part. Further, as stated, compressive grip surfaces may be established as part of the first plier jaw and the second plier jaw. Typically, such compressive grip surfaces will be as found on any pair of linesmans pliers and may have grooves or ridges (cross-hatched grooves, or ridges perhaps disposed perpendicular to the length axis of the tool as but a few examples). Of course, the compression referred to would be applied by a user of the tool. Many types of compression grip surfaces may look the same from the side of the tool, perhaps having a ˆˆˆˆˆˆˆˆˆprofile. Compressive grip surfaces may be added to separable surfaces (oppositely established surfaces that separate or approach one another during opening and closing of the tool, respectively) one the side of the axis of rotation that the handles are on without departing from the scope of the invention.

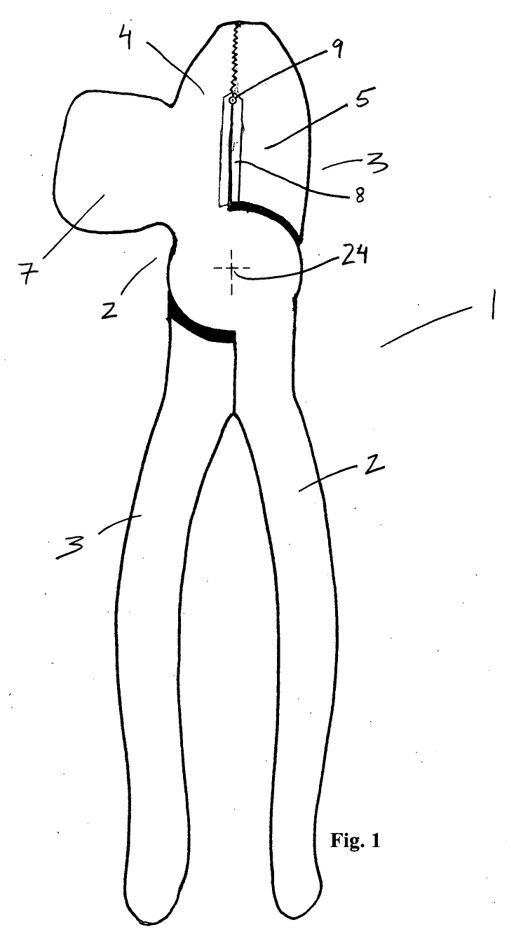

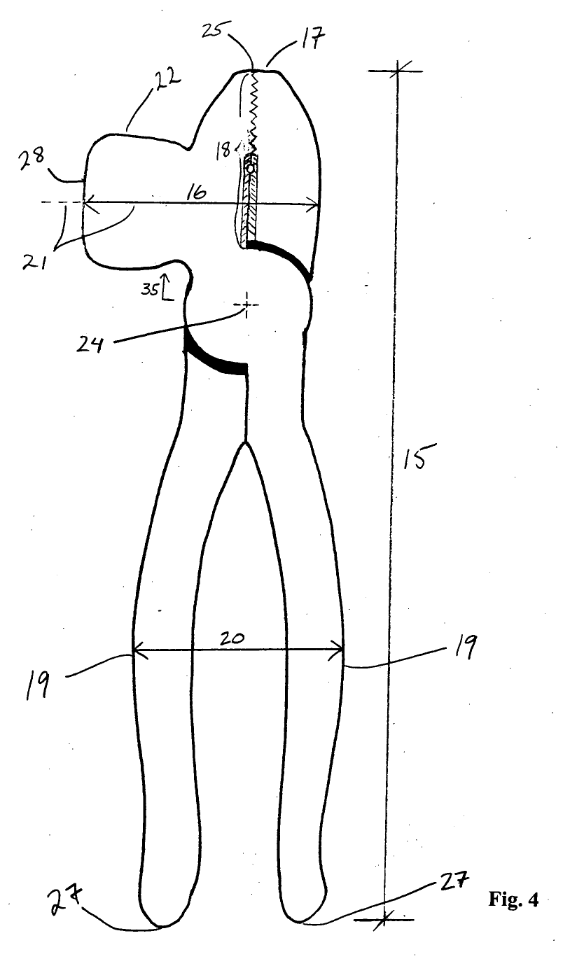

The wire stripper element may comprise surfaces usable to strip wire of various gauges (10 gauge, 12 gauge and 14 gauge, as but three examples). Such surfaces may form, in some embodiments, one or a plurality of holes (see FIG. 4) when the combination tool is in closed (i.e., when the jaws are rotated against one another, again, as shown in FIG. 4). In the design where the wire stripper element forms one hole when the tool is closed (see FIG. 1), the surfaces may be sized to strip one gauge of wire precisely, but still be usable to strip gauges of wire on either side of that “precisely dimensioned” gauge. For example, where the wire stripper element may have surfaces that only define one hole when the tool is closed, such element may be sized to precisely strip 12 gauge wire, but usable to adequately strip 10 gauge and 14 gauge wire also. As mentioned, in other embodiments, there may be provided a wire stripper element that has surfaces that, upon closing of the tool, defines a plurality (more than one) of holes, each hole perhaps sized to precisely strip a specific gauge of wire (e.g., 10, 12 and 14). The holes may be formed simply by drilling a hole(s) through a portion of the wire cutter element (when the tool is closed), thereby forming a wire stripper element. The hole(s) needs not be at the very top of the wire cutter element (e.g., on the very end of the wire cutter element furthest from the axis of rotation) to fall within the scope of the inventive technology, although in some embodiments (see FIG. 1), they certainly may be. Of course, even where the wire stripper element is formed by drilling a prior-existing wire cutter element, the two may, in particular embodiments, be deemed distinct features of the inventive technology.

The pair of pliers may comprise a handle 10 (a broad term that includes any structure(s) such as hand grips having a surface(s) adapted for contact by a human hand so that the tool may be manipulated as desired). The handle may be made up of a portion of each the first and second tool parts together, which themselves may comprise grippable surfaces (e.g., rubber or plastic sleeves 12) forming at least part of the exterior surface of the handles.

It should be noted that in at least one embodiment, the combination tool may have certain specific dimension (or at least dimension that fall within a specific range). For example, the tool may have an end to end length 15 of from 10″-11″, 9¾″ to 11¼″ (closed mode), and, in some more specific embodiments, a length of 10¼″. It may have a hammer head surface to opposite side 16 (closed mode) of from 2¼″ to 3″, or 2⅛″ to 2¾″, or 2¼″ to 2½″ and, in some more specific embodiments, such width may be 2 5/16″. The surfaces of the wire cutter element may, in certain embodiments, each be from ½″ to 1″, and, in some more specific embodiments, such length may be ¾. The compressive gripping surfaces of the plier jaws may, in certain embodiments, each be from ½ to 1″, and, in some more specific embodiments, such length may be ¾″. The wire stripper element (where it defines more than one hole when the tool is closed, the centroid of these holes) may be established from ½″-1″ from the tip of the plier jaws, and in certain embodiments, may be established ¾″ from the tip of the plier jaws. Expressed as a ratio of the separable jaw surfaces distance, the distance of the wire stripper element from the tip 17 of the plier jaws may be from ½ to ¾, or simply ⅝. Separable jaw surfaces 18 may be from 1½ to 2¼ in length, and in more specific embodiments, may be 2″ in length. When the tool is closed, the maximum distance 20 between outwardly facing parts 19 of grippable surfaces of the handle may be from 2″ to 2¾ and, in a preferred embodiment, 2⅛″.

The center line 21 of the hammer head may be from 1¼″ to 2″ (perpendicular distance) from the tip of the plier jaws and, in certain embodiments, this distance may be 1⅝″; expressed as a ratio of the entire length of the tool, this distance (perpendicular distance of the centerline of the hammer head to the tip of the plier jaws) may be ⅙. The hammer head may be established such that an edge 22 of the hammer head that is furthest from the axis of rotation 24 is more than one half inch (or ⅝″, or ¾″) closer to the handle than is a edge 25 of the compressive grip surfaces that is furthest from the axis of rotation. This is, of course, different from the typical placement of the hammer head on a hammer (where the upper edge of the hammer head is substantially the same distance from a point on the handle of the hammer as the upper edge of the hammer is). Such “establishment” of the hammer head as found in at least one embodiment of the inventive technology may play an important role, not only in providing an appropriate balance and/or leverage to the tool during hammering, but also in enhancing hammer swing accuracy (as placing a hammer head at the very end of a the tool may increase the frequency of swing accuracy errors as compared with the preferred design). Such “establishment” may also reduce the shock that may be felt upon impact after swing of a hammer having a hammer head at its very end.

It should be noted that all dimensions given, including those given as a ratio, are substantially as specified (meaning that measured distances that vary therefrom within ±10% are still deemed as having the specified length or falling within the specified range). Each of the dimensions, either alone or in combination with other dimensions, may play a role in enhancing the utility and operation of the tool (e.g., by optimizing balance, enhancing leverage during hammer swing, enabling fitting of the tool into a pocket, etc.). Of course, as mentioned, these dimensions apply to only certain embodiments.

The “order of appearance” on the tool relative to the end of the handles may, in at least one embodiment, be as follows: wire cutter element, wire stripper element, and plier compressive grip surfaces. All three, in addition to the hammer head, may be established on a side 35 of the axis of rotation that is distal the handle.

The functionalities selected in at least one embodiment (e.g., hammering, pliering, wire cutting and wire stripping as afforded by the hammer head, pliers, wire cutters and wire strippers, respectively) may be those that are most often needed for certain jobs such as wire installation or tinning (as but two examples). Indeed, only a certain number of functionalities (e.g., four) might be selected and enabled by the combination tool, and only specific functionalities in this number (i.e., four specific functionalities) might be enabled by the tool. They might each require only one handed manipulation, and their adaptation onto the tool (or their configuration as part of the tool) may be such that a change from any one functionality to any other functionality would not require two handed manipulation (e.g., there may be afforded a one-handed switching capability). It may also be that the structures of the tool affording each of the capabilities may be relatively oriented and positioned on the tool such that changing from one functionality to another (e.g., from wire stripping to hammering) does not even require a change of grip. Of course, the combination tool reduces the number of discrete, unitary tools that a user (a general term that includes electricians, tinners, linesmen, or other tradesman, or other type of laborer that might find the invention useful) must carry for a job.

The combination tool may be made from a variety of materials, including but not limited to: metal, metal alloy, steel, steel alloy, iron, iron alloy, composite metal, composite materials, plastics, fiberglass, rubber, etc. (as but a few examples). The tool may be made entirely of some of these materials (e.g., steel alloy), or merely a part of the tool may be made from some of these materials (e.g., a grippable sleeve around a handle of the tool may be rubber or plastic). It may be manufactured using known extrusion techniques, molding techniques, forging techniques, welding techniques, or any other techniques known in the field of tool manufacture.

The combination tool may be particularly suited for “roughing in” buildings during construction, installing wire (e.g., pulling, cutting and stapling wire), installing nail-on boxes for lights, switches and receptacles, and hammering nails (e.g., 16 penny framing nails), as but a few examples.

At least one embodiment of the invention may have a round-faced hammer head 13, where this shape may have resultant advantages relative to hammer contact (e.g., such a shape may improve the chances of hitting a nail relative to a hammer head of different shape (e.g., oval or square) but having the same hitting surface area).

At least one embodiment of the invention may be without a profoundly or sharply protruding feature (e.g., a nail-pulling claw or chisel) opposite the side of the combination tool on which the hammer head is situated 14, or even on any part of the combination tool. Resultant advantages may include reduction in weight, easier handling in a storage holder (e.g., a storage pouch), reduction in tool complexity, reduction in instances of snagging of tool or contact of tool with obstructing structures, facilitating insertion/removal of the tool into/from a pocket, and/or reduction of chance of puncture or scratching type injury. Indeed, as prior art suggests, providing a combination tool having a hammer head but not having a claw, as claimed, does indeed appear to counter the conventional “more is better” thinking relative to combination tools, particularly given that hammer heads rarely, if ever, appear without an oppositely established claw of sorts.

At least one embodiment of the invention may include a hammer head that is designed to impart the blow as opposed to receive it from another hammer.

At least one embodiment of the invention may be without any sharp protrusions; attendant advantages may include the reduction of risk of injury and/or the reduction in instances of annoying obstruction of the tool with nearby structures (including cloth of a pocket of a pair of pants, or a pocket in a tool belt).

In at least one embodiment of the invention, the hammer head may be further from the handle of the tool than is the axis of rotation of the plier jaws, such that the handle and the hammer head are on opposite sides of the axis of rotation. Thus, a distance from the end 27 of the handle to the axis of rotation of the plier jaws would, in such embodiment(s), be less than the distance from the end of the handle to the centerline of the hammer head. Such configuration may result in a weighting of the tool that effects a more leveraged and/or more comfortable or resonant hammer swing (compared to a configuration where the hammer head is closer to the handle than is the axis of rotation of the plier jaws). However, this is only a preferred of many embodiments.

In at least one embodiment of the invention, a centerline 21 of the hammer head (e.g., a line passing through the centroid of the face 28 of the hammer head and normal to this face) may lie in either or both of: (a) the plane in which the plier handles rotate; and/or (b) the plane in which the plier jaws rotate. Such configuration may have efficiency enhancing benefits, as a user's grip on the pliers while using the pliers might not need be adjusted when the user desires to use the hammer head (e.g., to hammer a nail).

In at least one embodiment of the invention, the hammer head may be attached to the proximal (relative to the tool handle) half 29 of one of the jaws of the pliers (instead of being attached to the distal part of one of the jaws). Such establishment may provide important benefits relative to swing accuracy, resonance of hammer strike, and/or reduction of the incidence (or the intensity of) dulling shock transferred to the arm of the tool user during some mis-strikes of the hammer head.

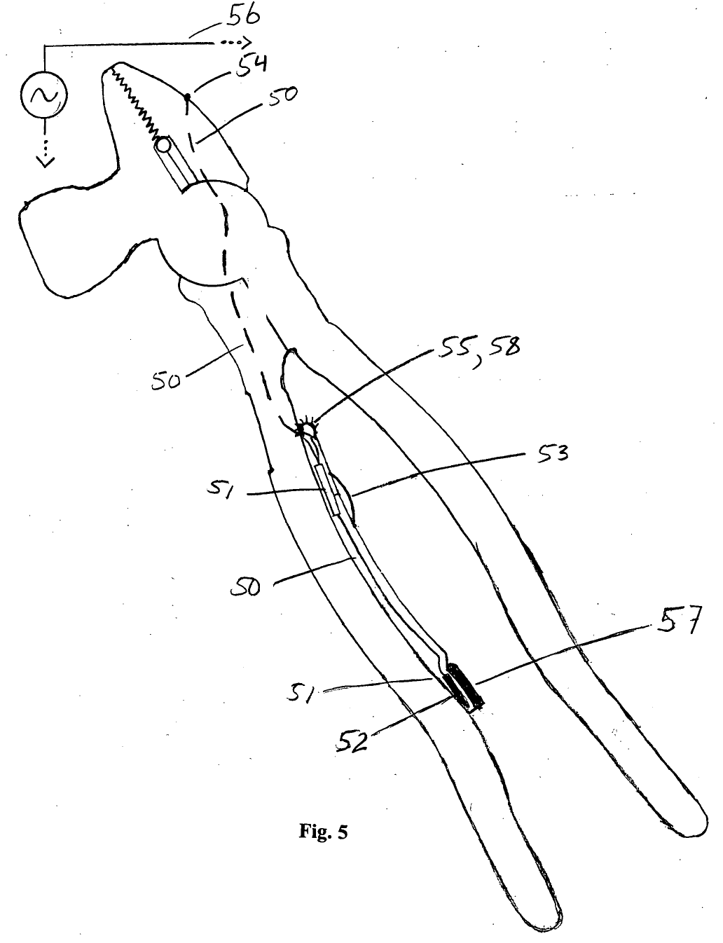

At least one embodiment of the inventive technology may also include a non-contact voltage sensor 50 having a voltage sense circuit 51 (which includes a power source such as a disc battery 52 and perhaps an on/off switch 53) established at least partly in the handle (whether embedded in the handle, e.g., under a rubberized grip thereof, embedded in the material making up the core of the handle (e.g., steel), or attached on an outer surface of the handle), a probe 54 established substantially at an end of either the first plier jaw or said second plier jaw (e.g., within an inch of the tip), and a voltage indicator 55 that indicates to a user of the combination tool apparatus when a conductive element 56 (e.g., a wire, whether insulated or not) in sufficient proximity to the probe is impressed with a voltage (e.g., is powered). The term “sufficient proximity” depends in part on the sensitivity of the sensor, as established, at least in part, on the voltage sense circuit; it may be, as but a few examples, less than 1½ inch, less than 1 inch, or less than ½ inch. There may be a screw cap (or other openable and closeable aperture 57) that may provide access to a battery housing. The voltage sensor circuit would be well known to one of ordinary skill in the art, and may be any of the variety of types disclosed in U.S. Pat. No. 4,724,382; U.S. Pat. No. 5,103,165; U.S. Pat. No. 5,363,045; U.S. Pat. No. 6,844,819; U.S. Pat. No. 6,828,767; U.S. Pat. No. 6,812,685; U.S. Pat. No. 6,731,218; U.S. Pat. No. 6,731,102; and U.S. Pat. No. 6,653,826 (as but a few examples of potential types of circuits), each said patent hereby incorporated by reference. The voltage indicator may be any of either a light (e.g., LED light) 58, an audible signal, or a tactile indicator (e.g., a vibrating “machine” that vibrates the tool, or a part thereof). In particular embodiments, the combination tool apparatus incorporating a non-contact voltage sensor may be able to sense from 90-600 volts. An example of an embodiment of a combination tool apparatus that incorporates a non-contact voltage sensor is as shown in FIG. 5.

A method related to the combination tool apparatus embodiment that incorporates a non-contact voltage sensor may include the steps of establishing a non-contact voltage sense circuit at least partly in said handle, establishing a probe substantially at an end of either said first plier jaw or said second plier jaw, and establishing a voltage indicator so as to indicates to a user of the combination tool apparatus when a conductive element in sufficient proximity to said probe is impressed with a voltage.

In at least one embodiment of the invention, the combination tool may be configured so that none of the tools requires finger manipulation to operate (e.g. there might be no finger adjustable wrench). Such a design may have resultant benefits relative to ease of use and efficiency.

In at least one embodiment of the invention, movement of structures during hammering and during the closure and opening of the pliers may occur in substantially the same plane.

In at least one embodiment of the invention, all parts of the tool may be solid (e.g., not hollow) for durability and for reasons relative to enablement of an effective hammer swing.

In at least one embodiment of the invention, the combination tool may comprise two rotatably mated parts that are the only parts that are movable (e.g., movable relative to one another). Thus, e.g., there might not be an additional screw-type part that is common on adjustable wrenches. However, even though there may only be two movable parts (a simple and easily manufactured design), the tool may afford at least four (or perhaps only four) functionalities.

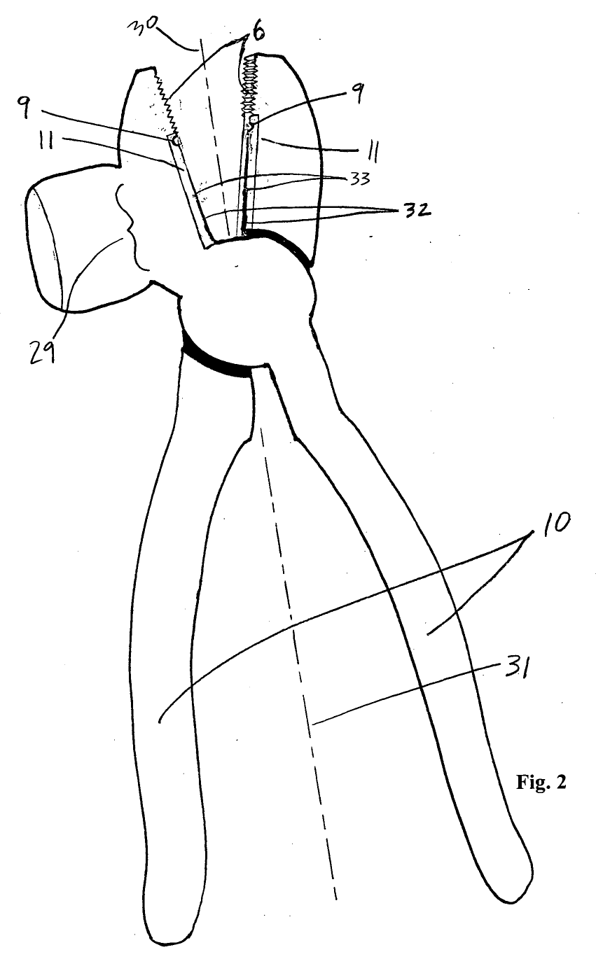

In at least one embodiment of the invention, the plier jaws may close towards a notional line 30 that substantially bisects them in their fully open position (see FIG. 2); this notional line may be parallel (and in a preferred embodiment, co-linear with) that notional line 31 which substantially bisects the handles of the tool. Advantages of this feature may include ease of use.

In at least one embodiment of the invention, the hammer head surface may be in a plane that is substantially parallel with the gripping surfaces of the jaws of the pliers when they are in a closed position. Such configuration may have benefits relative to efficiency of use, in that switching of tool functionality might not require a switching of grip or a rotation of wrists, elbow or shoulderjoint of the user.

In at least one embodiment of the inventive technology, wire cutting and wire stripping surfaces may be positioned on a side of the axis of rotation of the plier jaws that is opposite the side the handle is on, for facile, efficient positioning of the cutting or stripping surfaces around the wire or cable to be cut or stripped. Such a configuration may preclude the otherwise requisite removal of the user's hand, or the often awkward re-orientation of the tool relative to the wire or cable to be cut or stripped, resulting in a quicker, more efficient and less troublesome combination tool functionality switch or transfer.

In at least one embodiment of the invention, plier jaws may be substantially symmetric or identical, potentially reducing complexity of manufacture.

In at least one embodiment of the invention, wire cutters and strippers may be part of the opposing surfaces 11 of the jaws of the pliers; at least a portion of these opposing surfaces may be designed for gripping. In a preferred embodiment, the wire cutter element includes wire cutting surfaces 32, at least one of which is sharp edged 33.

At least one embodiment of the invention may not comprise (e.g., be without or not provide) finger adjustable wrench capability or functionality.

As can be easily understood from the foregoing, the basic concepts of the present inventive technology may be embodied in a variety of ways. It involves both tool usage and combination techniques as well as devices to accomplish the appropriate tool usage and combination. In this application, the tool combination and usage techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon for the claims in this or any subsequent patent application. The reader should be aware that this disclosure is to be understood to support any this and any subsequently filed patent application.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “wire cutter” should be understood to encompass disclosure of the act of “wire cutting”—whether explicitly discussed or not—and, conversely, were there effectively disclosure of the act of “wire cutting”, such a disclosure should be understood to encompass disclosure of a “wire cutter” and even a “means for wire cutting” Such changes and alternative terms are to be understood to be explicitly included in the description. As an important aside, and for purposes of clarity, the term element may include one or more structures or parts.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of references below or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the combination tool devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, and xii) each potentially dependent claim or concept as a dependency on each and every one of the independent claims or concepts presented.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A combination tool apparatus, comprising:
a first tool part and a second tool part rotatably movable relative to said first part about an axis of rotation,
wherein said first part comprises a first plier jaw and said second part comprises a second plier jaw that is established opposite said first plier jaw and rotatable relative to said first jaw about said axis of rotation,
said apparatus further comprising:
compressive grip surfaces established as part of said first plier jaw and said second plier jaw;
a hammer head fixedly established as part of said first tool part;
a wire cutter element adapted to cut wire during rotation of said first jaw towards said second jaw; and
a wire stripper element adapted to cut wire insulation during rotation of said first jaw towards said second jaw,
wherein a portion of each said first tool part and said second tool part together form a handle for grasping said combination tool apparatus, and
wherein said apparatus does not comprise a nail pulling claw.

2. A combination tool apparatus as described in claim 1 wherein said compressive grip surfaces, said wire cutter element and said wire stripper element are established on a side of said axis of rotation that is distal said handle.

3. A combination tool apparatus as described in claim 1 wherein said wire stripper element is adapted to strip wire insulation from at least two different gauges of wire.

4. A combination tool apparatus as described in claim 3 wherein said wire stripper element defines only one hole when said combination tool apparatus is in a closed mode.

5. A combination tool apparatus as described in claim 4 wherein said hole is precisely dimensioned to strip 12 gauge wire.

6. A combination tool apparatus as described in claim 1 wherein said hammer head is round faced.

7. A combination tool apparatus as described in claim 1 wherein said apparatus does not comprise a sharply protruding feature.

8. A combination tool apparatus as described in claim 1 wherein said hammer head is established on a side of said axis of rotation that is distal said handle.

9. A combination tool apparatus as described in claim 1 wherein said hammer head and said first and second plier jaws are established such that rotation of each said hammer head and said first and second plier jaws occurs in the same plane.

10. A combination tool apparatus as described in claim 1 wherein said wire cutter element and wire stripper element are part of the opposing surfaces of the jaws of the pliers.

11. A combination tool apparatus as described in claim 1 wherein said wire cutter element has at least one sharp edged cutting surface established on a plier jaw.

12. A combination tool apparatus as described in claim 1 wherein said hammer head may be established, relative to the tool handle, to the proximal half of one of the jaws of the pliers.

13. A combination tool apparatus as described in claim 1 wherein said compressive grip surfaces are established further from said handle than said wire stripper element, which itself is established further from said handle than said wire cutter element.

14. A combination tool apparatus as described in claim 1 wherein said hammer head is established such that an edge of said hammer head that is furthest from said axis of rotation is more than one half inch closer to said handle than is an edge of said compressive grip surfaces that is furthest from said axis of rotation.

15. A combination tool apparatus as described in claim 1 wherein a center line of said hammer head has a perpendicular distance to said axis of rotation that is at least one-half inch less than a distance of said wire stripper element to said axis of rotation.

16. A combination tool apparatus as described in claim 1 further comprising a non-contact voltage sensor having a voltage sense circuit established at least partly in said handle, a probe established substantially at an end of either said first plier jaw or said second plier jaw, and a voltage indicator that indicates to a user of the combination tool apparatus when a conductive element in sufficient proximity to said probe is impressed with a voltage.

17. A combination tool apparatus, comprising:
a first tool part and a second tool part rotatably movable relative to said first part about an axis of rotation,
wherein said first part comprises a first plier jaw and said second part comprises a second plier jaw that is established opposite said first plier jaw and rotatable relative to said first jaw about said axis of rotation,
said apparatus further comprising:
compressive grip surfaces established as part of said first plier jaw and said second plier jaw;
a hammer head fixedly established as part of said first tool part;
a wire cutter element adapted to cut wire during rotation of said first jaw towards said second jaw; and
a wire stripper element adapted to cut wire insulation during rotation of said first jaw towards said second jaw,
wherein a portion of each said first tool part and said second tool part together form a handle for grasping said combination tool apparatus,
wherein said compressive grip surfaces, said wire cutter element and said wire stripper element are established on a side of said axis of rotation that is distal said handle, and
wherein said hammer head is established such that an edge of said hammer head that is furthest from said axis of rotation is more than one half inch closer to said handle than is a edge of said compressive grip surfaces that is furthest from said axis of rotation.

18. A combination tool apparatus as described in claim 17 wherein said apparatus does not comprise a nail pulling claw.

19. A combination tool apparatus as described in claim 17 wherein a center line of said hammer head has a perpendicular distance to said axis of rotation that is at least one-half inch less than a distance of said wire stripper element to said axis of rotation.

20. A combination tool apparatus as described in claim 17 wherein said wire stripper element is adapted to strip more than one gauge of wire.

21. A combination tool apparatus as described in claim 17 wherein said hammer head is established such that an edge of said hammer head that is furthest from said axis of rotation is more than three-quarters of an inch closer to said handle than is a edge of said compressive grip surfaces that is furthest from said axis of rotation.

22. A combination tool apparatus as described in claim 17 further comprising a non-contact voltage sensor having a voltage sense circuit established at least partly in said handle, a probe established substantially at an end of either said first plier jaw or said second plier jaw, and a voltage indicator that indicates to a user of the combination tool apparatus when a conductive element in sufficient proximity to said probe is impressed with a voltage.

23. A combination tool apparatus consisting essentially of:
a first tool part and a second tool part rotatably movable relative to said first part about an axis of rotation,
wherein said first part comprises a first plier jaw and said second part comprises a second plier jaw that is established opposite said first plier jaw and rotatable relative to said first jaw about said axis of rotation,
said apparatus further consisting essentially of:
compressive grip surfaces established as part of said first plier jaw and said second plier jaw;
a hammer head fixedly established as part of said first tool part;
a wire cutter element adapted to cut wire during rotation of said first jaw towards said second jaw; and
a wire stripper element adapted to cut wire insulation during rotation of said first jaw towards said second jaw,
wherein a portion of each said first tool part and said second tool part together form a handle for grasping said combination tool apparatus.

24. A combination tool apparatus as described in claim 23 wherein said hammer head is established such that an edge of said hammer head that is furthest from said axis of rotation is more than one half inch closer to said handle than is an edge of said compressive grip surfaces that is furthest from said axis of rotation.

25. A combination tool apparatus as described in claim 23 wherein a center line of said hammer head has a perpendicular distance to said axis of rotation that is at least one-half inch less than a distance of said wire stripper element to said axis of rotation.

26. A combination tool apparatus as described in claim 23 further comprising a non-contact voltage sensor having a voltage sense circuit established at least partly in said handle, a probe established substantially at an end of either said first plier jaw or said second plier jaw, and a voltage indicator that indicates to a user of the combination tool apparatus when a conductive element in sufficient proximity to said probe is impressed with a voltage.

27-36. (canceled)
